(19) United States
(12) Patent Application Publication
(10) Pub. No.: US 2026/0371205 A1
(43) Pub. Date: Nov. 19, 2026

(54) ZERO-SCAN ROAMING WITH RECEIVED SIGNAL STRENGTH INDICATOR FEEDBACK

(71) Applicant: Cisco Technology, Inc., San Jose, CA (US)

(72) Inventors: Jerome Henry, Pittsboro, NC (US); Ugo Mario Campiglio, Morges (CH); Domenico Ficara, Essertines-sur-Yverdon (CH); Federico Lovison, Fontanelle (IT)

(21) Appl. No.: 19/677,317

(22) Filed: May 14, 2026

Related U.S. Application Data
(60) Provisional application No. 63/805,811, filed on May 14, 2025.

(51) Int. Cl. H04W 36/30

(52) U.S. Cl. CPC H04W 36/302

(57) ABSTRACT

Zero-scan roaming with Received Signal Strength Indicator (RSSI) feedback may be provided. Providing zero-scan roaming includes receiving, from a station (STA) performing a roaming event from a source access point (AP) to a target AP, a report comprising one or more RSSI values measured at the STA at a time of the roaming event. Based at least on the one or more RSSI values measured at the STA, a midpoint RSSI value is determined for a roaming transition between the source AP and the target AP, the midpoint RSSI value representing a signal condition at which roaming between the source AP and the target AP is to be performed. A frame is transmitted to a subsequent STA associated with the source AP comprising the midpoint RSSI value to enable the subsequent STA to determine when to initiate roaming toward the target AP.

### RELATED APPLICATION

Under provisions of 35 U.S.C. § 119(e), Applicant claims the benefit of and priority to U.S. Provisional Application No. 63/805,811, filed May 14, 2025, the disclosure of which is incorporated herein by reference in its entirety.

### TECHNICAL FIELD

The present disclosure relates generally to providing zero-scan roaming with received signal strength indicator feedback.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for zero-scan roaming with STA RSSI feedback in accordance with aspects of the present disclosure.

FIG. 2 illustrates an example Reassociation Request frame in accordance with aspects of the present disclosure.

FIG. 3 illustrates an example Neighbor Report element in accordance with aspects of the present disclosure.

FIG. 4 illustrates an example BTM Request frame in accordance with aspects of the present disclosure.

FIG. 5 illustrates an example deauthentication or disassociation frame in accordance with aspects of the present disclosure.

FIG. 6 illustrates a signaling process for roaming using STA RSSI feedback in accordance with aspects of the present disclosure.

FIG. 7 is a flow diagram illustrating a method for zero-scan roaming with STA RSSI feedback in accordance with aspects of the present disclosure.

FIG. 8 is a block diagram of a computing device in accordance with aspects of the present disclosure.

FIG. 9 is a block diagram of a communications device in accordance with aspects of the present disclosure.

### DETAILED DESCRIPTION

### Overview

Zero-scan roaming with Received Signal Strength Indicator (RSSI) feedback may be provided. Providing zero-scan roaming includes receiving, from a station (STA) performing a roaming event from a source access point (AP) to a target AP, a report comprising one or more RSSI values measured at the STA at a time of the roaming event. Based at least on the one or more RSSI values measured at the STA, a midpoint RSSI value is determined for a roaming transition between the source AP and the target AP, the midpoint RSSI value representing a signal condition at which roaming between the source AP and the target AP is to be performed. A frame is transmitted to a subsequent STA associated with the source AP comprising the midpoint RSSI value to enable the subsequent STA to determine when to initiate roaming toward the target AP.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless networks enable users to maintain connectivity while moving through different coverage areas. In traditional roaming methods, a wireless device, referred to as a Station (STA), scans available channels when transitioning between network devices, referred to as Access Points (APs), to identify the best available AP for connection. The STA typically scans across one or more entire radio bands to identify available APs. This scanning process, however, introduces latency, consumes client power, increases channel congestion, and can disrupt connectivity. Therefore, scanning can result in interruptions that degrade the user experience, particularly for latency-sensitive applications such as voice over Wi-Fi or real-time streaming.

To address these challenges, various methods have been developed to enable seamless roaming across Wi-Fi networks. Zero-scan roaming is a wireless communication technique that enables a STA to transition between APs within a wireless network without performing an active or passive channel scan or performing a reduced number of scans. By bypassing or reducing the scanning phase of roaming, zero-scan roaming reduces handoff latency, minimizes packet loss, conserves client power, and improves the overall user experience.

Zero-scan roaming typically involves mechanisms that assist the STA in making informed roaming decisions without requiring extensive scanning operations. For example, the Institute of Electrical and Electronics Engineers (IEEE) 802.11k amendment describes a process to create and share a neighbor report containing information about known neighbor APs that are candidates for a service set transition. A STA can utilize the neighbor report to identify available APs without performing a full scan and can avoid connecting to an overutilized or otherwise congested AP simply because that AP has the strongest signal at the time the STA determines to roam. When certain transition conditions are met (e.g., signal degradation, load balancing triggers, or motion detection), the STA can determine to roam to an AP included in the received neighbor report without performing a scan operation, or may perform scanning only for one or more of the APs included in the neighbor report.

Similarly, the IEEE 802.11v amendment defines Basic Service Set (BSS) Transition Management (BTM), which enables an STA to send a BTM query requesting information about the next optimal AP from the AP to which the STA is currently connected. The AP may then recommend an optimal neighboring AP for roaming. For example, when a STA approaches the edge of a coverage area (e.g., a cell or a Basic Service Area (BSA)) serviced by an AP, the AP may suggest a neighboring AP to which the STA can roam.

Despite the advantages of zero-scan roaming, current implementations face several limitations. Neighbor reports may be limited to the “loudest” (e.g., highest detected signal strength) neighbors around the current AP from the current AP’s viewpoint. While the neighbor report enables a STA to limit scanning to a subset of channels (e.g., channels of the APs in the list), the list of channels to scan may still be long and may lack prioritization. Additionally, the STA may not be able to detect each AP in the neighbor report list. For example, a STA moving in one direction may detect only a subset of the APs in the list in that direction, while a STA moving in another direction may detect a different subset of APs. Furthermore, the STA may be moving away from a recommended neighboring AP, making the recommended AP an unsuitable choice for roaming. Response times for BTM queries can also be significant, sometimes up to 400 milliseconds, leading to delays and interruptions in connectivity. The STA may also need to reach the edge of the cell serviced by the AP before detecting the next optimal AP, which can result in delays and interrupt seamless connectivity. As a result, roaming continues to face challenges in meeting user expectations for seamless and uninterrupted connectivity.

In zero-scan roaming, the network infrastructure can provide a STA with information about candidate APs along with an indication of the signal conditions at which the STA is likely to find the next AP. This signal condition corresponds to a spatial midpoint between the coverage areas of the current AP and the candidate AP, referred to herein as the roaming midpoint. By using this midpoint information, the STA can initiate scanning or the roaming procedure at the optimal time, avoiding the inefficiency of static roaming thresholds. A static threshold that is set too conservatively causes the STA to scan too early, potentially before a suitable candidate AP is detectable (e.g., in low-density deployments such as warehouses or manufacturing facilities where coverage areas are large and neighboring APs may be far apart). Conversely, a threshold set too aggressively causes the STA to begin roaming too late, after the signal from the current AP has already significantly deteriorated or another AP can otherwise provide better a connection (e.g., in high-density environments where APs are closely spaced and signal degradation can occur rapidly). The roaming midpoint can be expressed in multiple ways, including being expressed as the Received Signal Strength Indicator (RSSI) value that the STA observes from the current AP when the STA reaches the midpoint location. Machine learning (ML) or artificial intelligence (AI) techniques employed by the Extended Service Set (ESS) infrastructure can be used to learn and refine these midpoints over time based on historical roaming events between AP pairs. In existing approaches, the AP includes in the IEEE 802.11k neighbor report an RSSI threshold representing the signal level at which prior STAs have successfully roamed to each candidate AP. This threshold, however, is derived from RSSI as measured by the network infrastructure, such as the signal strength of transmissions from the STA as received at the AP at the time of a successful roam. This AP-measured RSSI value is then communicated to subsequent STAs as guidance for when to initiate roaming.

A fundamental limitation of this approach is that RSSI measurements are not reciprocal. The RSSI measured by a STA for signals received from an AP is generally different from the RSSI measured by the AP for signals received from that same STA on the same wireless link. This asymmetry arises from several factors, including differences in transmit power between the STA and the AP, differences in antenna configuration, and hardware-specific characteristics of each device. Because a STA determines its own RSSI measurements to make roaming decisions, an AP-measured RSSI threshold is not directly actionable by the STA. The STA cannot directly compare such a threshold against its own observations, introducing inaccuracy into the roaming decision. Furthermore, STAs from different manufacturers or device classes may exhibit substantially different AP-measured RSSI values at the same physical location due to variation in transmit power and antenna characteristics, making a single AP-measured threshold a poor predictor of the optimal roaming point for a given STA type.

The present disclosure addresses these limitations by introducing mechanisms through which the network infrastructure can determine and communicate roaming midpoint thresholds expressed in terms of STA-measured RSSI. STAs can therefore utilize the signal strength that a STA is likely to observe when receiving transmissions from a candidate AP at the roaming midpoint location rather than AP determined signal strength measurements. Because roaming decisions are made by the STA based on its own signal measurements, STA-measured RSSI thresholds provide more accurate and directly actionable guidance than AP-measured RSSI thresholds. Moreover, STAs of the same type or device class tend to exhibit similar RSSI measurements at the same physical location, making STA-measured thresholds more generalizable and consistent across STAs of the same class than AP-measured thresholds are.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

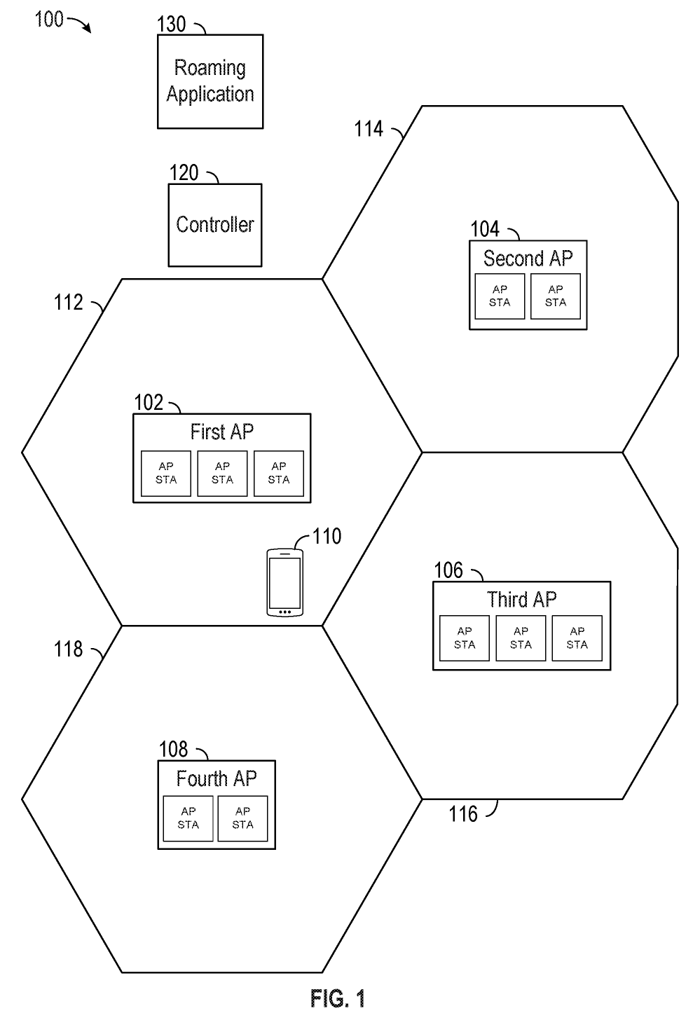

FIG. 1 is a block diagram of an operating environment 100 for zero-scan roaming with STA RSSI feedback. In the illustrated embodiment, the operating environment 100 includes a first AP 102, a second AP 104, a third AP 106, a fourth AP 108, a STA 110, a controller 120, and a roaming application 130. The first AP 102 has a service area or cell indicated by the first cell 112. Similarly, the second AP 104 has the second cell 114, the third AP 106 has the third cell 116, and the fourth AP 108 has the fourth cell 118. The range of the first AP 102, the second AP 104, the third AP 106, and the fourth AP 108 may extend past the boundary of the associated cells, but the signals of the APs grow weaker past the boundaries of the respective cells. Thus, the first AP 102, the second AP 104, the third AP 106, and the fourth AP 108 may fail to communicate with devices some distance past the edges of the associated cells. The edges of the first cell 112, the second cell 114, the third cell 116, and the fourth cell 118 as shown in the operating environment 100 are an example and may be different in other examples (e.g., different sizes, shapes, etc.).

The STA 110 is any device that connects to the network to communicate with other devices on the network, such as a smart phone, a tablet, a personal computer, a server, and/or the like. The controller 120 may be any network controller (e.g., a WLAN controller) and may provision, control, and otherwise manage the first AP 102, the second AP 104, the third AP 106, the fourth AP 108, and/or other network devices to allow wireless devices such as the STA 110 to connect to the network.

The first AP 102, the second AP 104, the third AP 106, and/or the fourth AP 108 may be Multi-Link Devices (MLDs) each including multiple AP STAs. For example, the first AP 102 is illustrated as having three AP STAs, and the third AP 106 is illustrated as having two AP STAs. However, each AP can have any number of AP STAs in further embodiments. Each AP STA may include Physical (PHY)-layer and lower-Media Access Control (MAC) components. The first AP 102, the second AP 104, the third AP 106, and the fourth AP 108 may also include an upper-MAC for coordinating the AP STAs and providing Logical Link Control (LLC).

Each AP STA may act as an AP and a single link of the respective MLD, and each AP STA of a respective AP may use a different channel. For example, the first AP 102 may include three AP STAs, with one AP STA operating on one of the channels of the 2.4 Gigahertz (GHz) band (e.g., channel one with center frequency 2.412GHz, channel two with center frequency 2.417GHz, channel three with center frequency 2.422GHz, etc.), one AP STA operating on a channel of the 5GHz band, and one AP STA operating on a channel of the 6GHz band. The first AP 102, the second AP 104, the third AP 106, and the fourth AP 108 may be co-channel APs, with the respective AP STAs operating on one or more of the same channels. Clients, such as the STA 110, can link or connect to one or more AP STAs of the first AP 102, the second AP 104, the third AP 106, and the fourth AP 108. In other embodiments, APs and client devices are single-link devices.

The roaming application 130 can operate on one or more devices, such as a cloud server, the controller 120, one or more of the first AP 102, the second AP 104, the third AP 106, and the fourth AP 108, and/or another network infrastructure device. The roaming application 130 can determine roaming midpoints and other roaming characteristics for zero-scan roaming. In some embodiments, the roaming application 130 uses ML or AI techniques to learn and refine roaming midpoints over time based on historical roaming events between AP pairs, based on STA RSSI feedback as described in further detail herein. The roaming application 130 can communicate with the APs and the controller 120 to receive RSSI and other roaming information and to provide roaming midpoint information and other roaming information to the network. In some embodiments, the operations of the controller 120 or the roaming application 130 described herein may be performed by one or more of the first AP 102, the second AP 104, the third AP 106, the fourth AP 108, or another device, and vice versa. The operating environment 100 is an example configuration and there may be a different number of STAs, APs, controllers, and/or other devices in further examples.

The systems of the network, including the first AP 102, the second AP 104, the third AP 106, the fourth AP 108, the controller 120, and/or the roaming application 130, can enable zero-scan roaming by determining and communicating roaming midpoint thresholds to STAs such as the STA 110. A roaming midpoint represents the optimal signal conditions at which a STA transitioning between two APs should initiate the roaming procedure. For example, the roaming midpoint is the point at which the STA is positioned to successfully complete a roam without having initiated scanning too early (before the target AP is reliably detectable) or too late (after the connection to the source AP has already deteriorated significantly). The roaming midpoint for an AP pair can be expressed as the RSSI value the STA is expected to observe when receiving transmissions from the source AP at the midpoint location, and/or the RSSI value the STA is expected to observe when receiving transmissions from the target AP at that location. These midpoint thresholds are expressed in terms of STA-measured RSSI (e.g., the signal strength as received at the STA) rather than AP-measured RSSI. Because a STA makes roaming decisions based on its own received signal strength measurements, STA-measured RSSI thresholds are directly actionable by the STA and more accurately guide the STA to roam at the optimal time. Furthermore, STAs of the same device type or brand tend to exhibit similar received signal strength measurements at the same physical location, making STA-measured midpoint thresholds more broadly applicable across STAs of the same device class than AP-measured thresholds.

To obtain STA-measured RSSI data, the present disclosure proposes extensions to existing roaming protocols that enable a STA to report to the network infrastructure the RSSI values it observed at the time of a roaming event. Specifically, a STA (e.g., the STA 110) reports the RSSI of the last packet received from the AP to which it was connected (the source AP), such as the first AP 102, and the RSSI of the first packet received from the AP to which it is roaming (the target AP), such as the second AP 104, the third AP 106, or the fourth AP 108, at the time the roaming decision is made. The target AP records these reported measurements and, upon a successful roam, shares them with the roaming application 130 for learning. The target AP may share this information directly with the source AP, which accumulates measurements over time and computes a representative midpoint RSSI value from the STA’s perspective for the AP pair. The resulting midpoint threshold is then included in neighbor reports or BTM frames provided to subsequent STAs, enabling those STAs to initiate roaming at the optimal time based on their own signal observations. The learning is performed on an AP-pair basis, including determining the midpoint threshold for roaming in each direction for AP pairs. For example, the midpoint threshold from the first AP 102 to the second AP 104 may differ from the midpoint threshold for roaming from the second AP 104 to the first AP 102. In example implementations, STA device model or brand information, when known or detectable, is used to further refine midpoint thresholds on a per-device-class basis, enabling more precise roaming guidance tailored to the RF characteristics of specific STA types.

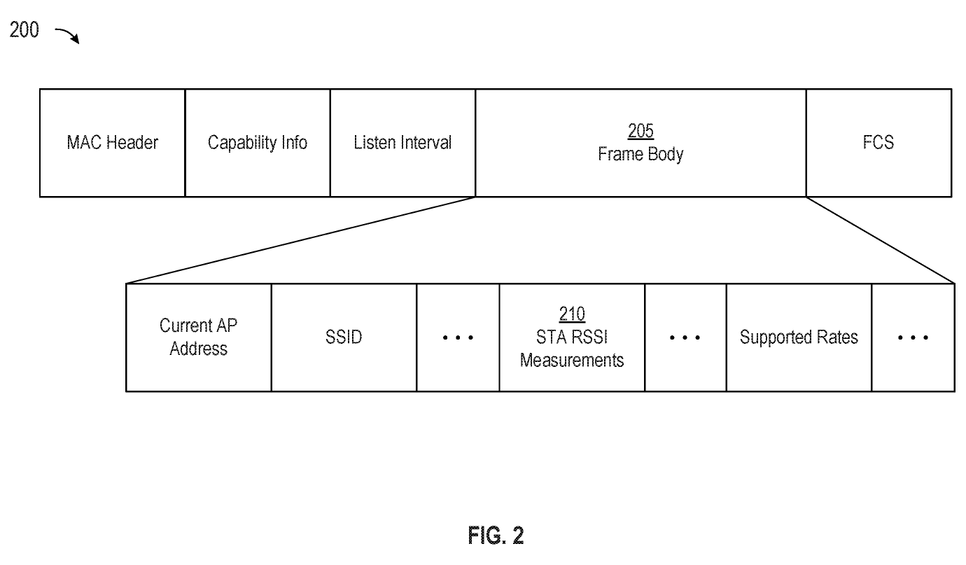

Multiple embodiments are disclosed for how a STA reports its RSSI measurements to the network infrastructure. FIGS. 2-5 illustrate example frames and frame elements used in connection with these embodiments. In some embodiments, the STA includes its RSSI measurements in the Reassociation Request frame transmitted to the target AP when initiating roaming. In certain embodiments, the neighbor report element or BTM Request frame transmitted by the source AP includes a flag requesting that the STA report its RSSI measurements, and the STA may respond with those measurements in its Reassociation Request frame or in a subsequent frame.

In some embodiments, the STA’s RSSI measurements are included in the disassociation or deauthentication frame transmitted to the source AP at the time of departure. In certain embodiments, the STA communicates its RSSI measurements to the target AP after successful re-association via a new action frame. In another embodiment, the target AP issues an IEEE 802.11k beacon report request to the STA after re-association, and the STA responds with its observed RSSI values for both the source AP and the target AP. In all embodiments, the network infrastructure obtains a view of the STA’s signal conditions at or near the roaming midpoint and uses this information to populate midpoint RSSI values in future neighbor reports or BTM frames provided to subsequent STAs.

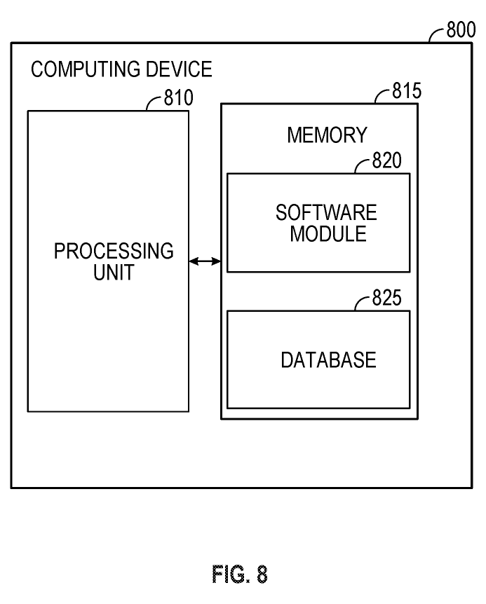

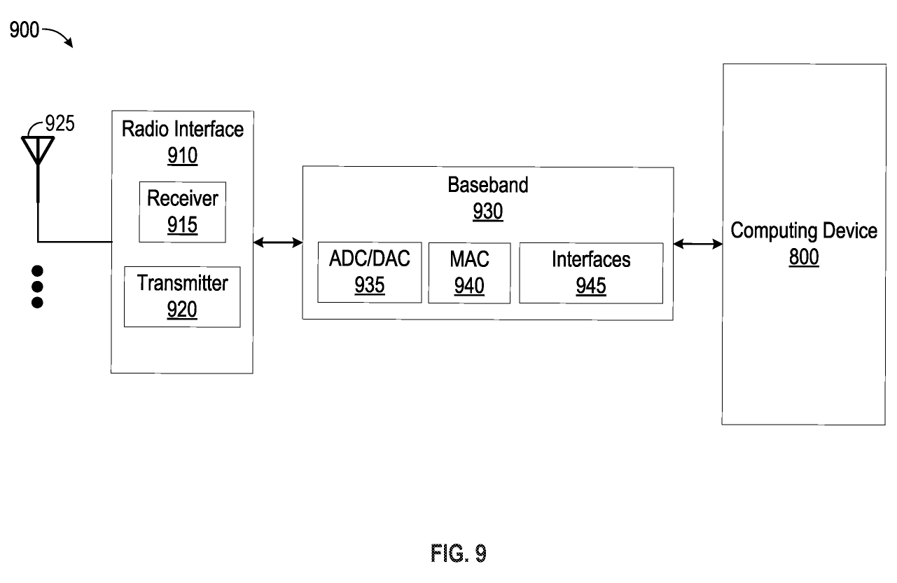

The elements described above of the operating environment 100 (e.g., the first AP 102, the second AP 104, the third AP 106, the fourth AP 108, the STA 110, the controller 120, the roaming application 130, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 8 and 9, the elements of the operating environment 100 may be practiced in a computing device 800 and/or communications device 900.

FIG. 2 illustrates an example Reassociation Request frame 200. A STA sends the Reassociation Request frame 200 to an AP when the STA is already associated to the ESS and wants to associate to another AP in the ESS. For example, the STA 110 sends the Reassociation Request frame 200 to a target AP, such as the second AP 104, when initiating roaming to that target AP.

As illustrated, the body 205 of the Reassociation Request frame 200 includes a STA RSSI Measurements field 210. The STA RSSI Measurements field 210 carries the RSSI measurements taken by the STA that reflect the signal conditions at which the STA made the decision to roam. Specifically, the STA RSSI Measurements field 210 includes the RSSI of the last packet received by the STA from the source AP (e.g., a beacon, probe response, or any other received frame) and the RSSI of the first packet received by the STA from the target AP (e.g., a beacon, probe response, or other received frame) at the time the roaming decision was made. Together, these two measurements capture the STA’s view of both the source and target APs at the physical location at which the roaming decision occurred, which is at or near the roaming midpoint for the AP pair.

Upon receiving the Reassociation Request frame 200, the target AP records the RSSI measurements in the STA RSSI Measurements field 210 and, if the roam is successful, shares them with the roaming application 130. In some embodiments (e.g., non-cloud deployments), the target AP may instead share this information directly with the source AP, which accumulates measurements over time and computes a representative midpoint RSSI value from the STA’s perspective for the AP pair. Over time, the roaming application 130 or the source AP builds a mean or otherwise representative value of the RSSI as measured by STAs at which successful roaming occurred for each AP pair. This information can be augmented with the STA device model or brand (if available or detectable) such that similar STAs are grouped and per-brand or per-device AI/ML models or mean values are defined. Based on the collected data, the roaming application 130, or the source AP in non-ML deployments, establishes the most effective midpoint RSSI values for each AP pair and provides these values to the network for inclusion in neighbor reports and BTM frames for subsequent STAs.

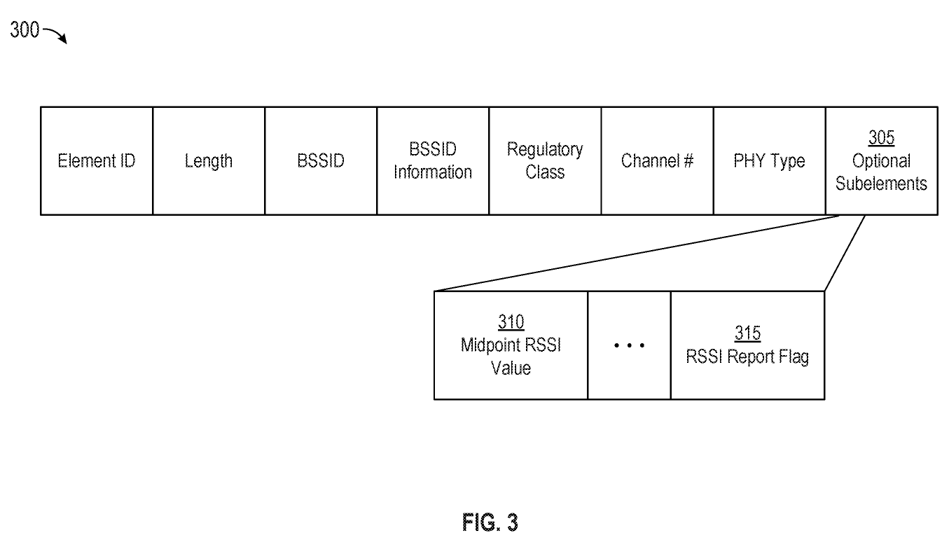

FIG. 3 illustrates an example Neighbor Report element 300. An AP can send to a STA a management frame (e.g., a neighbor report response, beacon frame, probe response, or BTM Request frame) including one or more Neighbor Report elements 300, with each Neighbor Report element 300 providing information about a respective candidate AP for roaming. The illustrated Neighbor Report element 300 includes a midpoint RSSI value field 310 in the optional subelements 305. The midpoint RSSI value field 310 carries the midpoint RSSI values for the AP pair associated with the respective Neighbor Report element 300, including the RSSI value the STA is expected to observe from the source AP at the roaming midpoint and/or the RSSI value the STA is expected to observe from the candidate target AP at the roaming midpoint. As described above, these midpoint RSSI values are derived from historical STA-measured RSSI data collected during prior successful roaming events between the AP pair. Accordingly, the midpoint RSSI value field 310 reflects the signal conditions as experienced by prior STAs at the roaming location, rather than signal conditions as measured by the AP infrastructure. The midpoint RSSI values may be tailored to the device model, brand, or other characteristics of the receiving STA, if known or detectable, such that the values more accurately reflect the expected signal conditions for that particular STA type.

The optional subelements 305 also include an RSSI Report Flag 315. The RSSI Report Flag 315 can be set by the source AP to request that the STA report its RSSI measurements for both the source AP and the target AP upon roaming, and also signals to the STA that the RSSI reporting mechanism is supported by the network infrastructure. The RSSI Report Flag 315 may specify variations on when and what to report. For example, the STA may be requested to report when the target AP is first detected, when roaming to the target AP has been completed, or both. In all cases, the requested report includes the RSSI at which the STA heard the target AP and the RSSI at which the STA heard the source AP at the same point in time and space. In one embodiment, the STA provides these measurements in the Reassociation Request frame 200, as described with respect to FIG. 2.

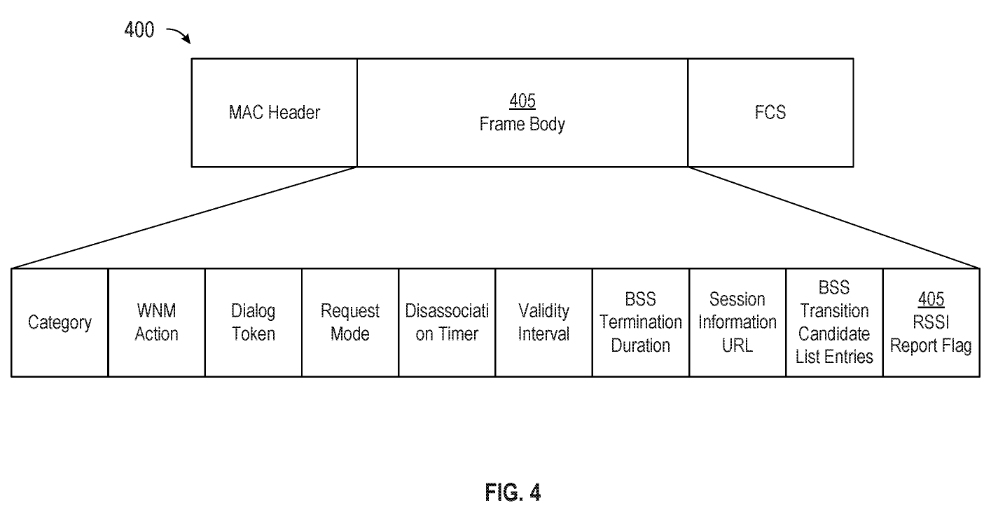

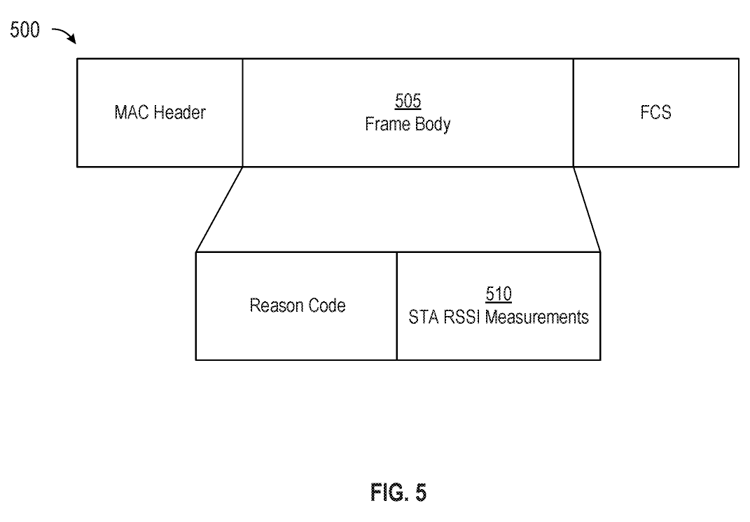

FIG. 4 illustrates an example BTM Request frame 400. As illustrated, the BTM Request frame 400 includes an RSSI Report Flag 410 in its frame body 405. Similar to the RSSI Report Flag 315 described with respect to FIG. 3, the RSSI Report Flag 410 can be set by the source AP to request that the STA report its RSSI measurements for both the source AP and the target AP upon roaming, and signals to the STA that the RSSI reporting mechanism is supported by the network infrastructure. The RSSI Report Flag 410 may likewise specify variations on when and what to report (e.g., upon first detection of the target AP, upon roaming completion, or both). Whether the RSSI reporting request is received via the RSSI Report Flag 315 of a Neighbor Report element 300 or the RSSI Report Flag 410 of a BTM Request frame 400, the STA can satisfy the request by including its measurements in the Reassociation Request frame 200 as described with respect to FIG. 2, or via one of the alternative reporting mechanisms described below with respect to FIG. 5.

FIG. 5 illustrates an example deauthentication or disassociation frame 500. A STA or AP can send a deauthentication frame when all communications are to be terminated. When a STA is associated to an AP, either side can terminate the association at any time by sending a disassociation frame, which shares the same frame format as a deauthentication frame. In the context of roaming, a STA can send a disassociation or deauthentication frame 500 to the source AP when transitioning to a target AP.

In the illustrated embodiment, the frame body 505 of the deauthentication or disassociation frame 500 includes a STA RSSI Measurements field 510. When roaming, the STA includes in the STA RSSI Measurements field 510 its RSSI measurements for both the source AP and the target AP, including the RSSI of the last packet received from the source AP and the RSSI of the first packet received from the target AP at the time the roaming decision was made. Transmitting these measurements to the source AP in the deauthentication or disassociation frame makes the data immediately available at the source AP without requiring any subsequent communication between the source AP and the target AP, which may be particularly advantageous in non-ML or non-cloud deployments.

In other embodiments, the STA communicates its RSSI measurements to the target AP after successful re-association via a new action frame. Because RSSI measurements are transmitted only following a successful roam in this embodiment, the data collected by the infrastructure is limited to measurements from successful roaming events, which may produce more accurate midpoint learning data by excluding measurements from unsuccessful roaming attempts.

In the certain embodiments, the target AP, immediately after re-association completes, sends an IEEE 802.11k beacon report request to the STA specifying both the source AP and the target AP. The STA responds with a beacon report that includes the RSSI at which the source AP was last heard and the RSSI at which the target AP was last observed (e.g., during the scan that preceded roaming). This provides the network infrastructure, through the target AP, with the STA’s RF perspective of both APs at a location close to the point at which roaming successfully occurred. Utilizing the beacon report leverages existing IEEE 802.11k beacon report mechanisms without requiring modification to the Reassociation Request frame 200 or other standard frame formats, and may therefore be deployable without changes to STA software stacks. However, because the beacon report reflects the STA’s signal measurements at the time the request is issued (e.g., after re-association has completed) rather than at the precise moment the roaming decision was made, the resulting RSSI measurements may be marginally less accurate than those obtained at the moment of roaming in the embodiments described above with respect to FIGS. 2-5, particularly if the STA has moved since the point at which roaming occurred, while still remaining more accurate than AP RSSI measurements.

In all of the described embodiments, the network infrastructure obtains a view of the STA’s signal conditions for both the source AP and the target AP at or near the point at which the STA successfully found the target AP, made the roaming decision, or completed the roam. The network infrastructure, through the roaming application 130, the target AP, the source AP, or a combination thereof, uses this collected data to populate the midpoint RSSI values in neighbor reports and BTM frames provided to subsequent STAs, improving roaming accuracy over time as additional roaming events are collected for each AP pair.

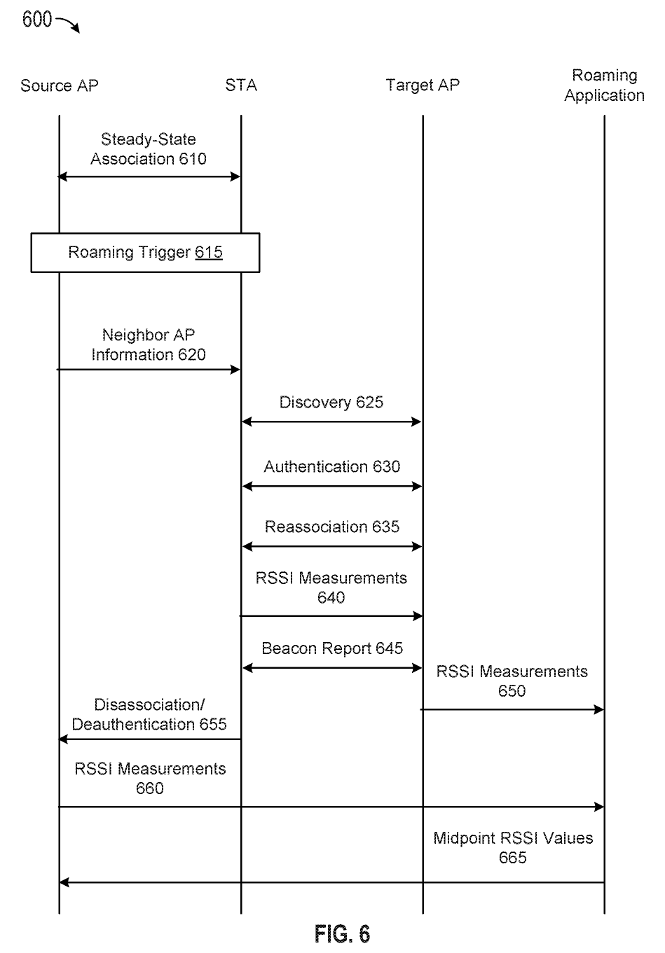

FIG. 6 illustrates a signaling process 600 for roaming using STA RSSI feedback. The signaling process 600 is performed among a source AP, a STA, and a target AP.

In operation 610, the STA is in steady-state association with the source AP. During this period, the STA and the source AP exchange data and maintain an active session. The source AP may also communicate with the STA to provide or update network information, for example by sending neighbor reports or initiating BTM exchanges.

In operation 615, a roaming trigger occurs. The roaming trigger may originate from the STA (e.g., due to detected signal degradation, increased retries, or packet loss), from the source AP (e.g., due to load balancing, band steering, or sticky-client logic), or from a WLAN controller (e.g., the controller 120). The roaming trigger causes the STA or the network to initiate the roaming procedure.

In operation 620, the source AP sends neighbor AP information to the STA. The neighbor AP information may be provided in a Neighbor Report element 300, a BTM Request frame 400, or another suitable management frame. The neighbor AP information includes, for each candidate target AP, the midpoint RSSI values for the AP pair (e.g., the RSSI value the STA is expected to observe from the source AP and/or from the candidate target AP at the roaming midpoint location). These midpoint RSSI values have been determined from historical STA-measured RSSI data collected during prior roaming events between the AP pair, as described herein. The neighbor AP information may also include an RSSI Report Flag (e.g., RSSI Report Flag 315, 410) to request that the STA report its RSSI measurements upon roaming and to signal that the RSSI reporting mechanism is supported by the network infrastructure.

In operation 625, the STA initiates discovery of the target AP. The STA uses the midpoint RSSI values received in operation 620 to determine when to initiate the discovery process. For example, the STA monitors its received signal strength from the source AP and, when the observed RSSI approaches the midpoint RSSI value for the source AP, initiates discovery of the target AP indicated in the neighbor AP information. Because the STA leverages the midpoint RSSI values from the neighbor AP information to identify the target AP without performing a full channel scan, the STA can locate and detect the target AP using zero-scan or reduced-scan roaming techniques.

In operation 630, the STA and the target AP perform authentication. In operation 635, the STA and the target AP perform re-association. The STA sends a Reassociation Request frame 200 to the target AP. In a first embodiment, the Reassociation Request frame 200 includes a STA RSSI Measurements field 210 carrying the RSSI of the last packet received by the STA from the source AP and the RSSI of the first packet received by the STA from the target AP at the time the roaming decision was made. The target AP responds with a Reassociation Response frame, completing the re-association.

In optional operation 640, the STA sends an action frame to the target AP with its RSSI measurements for both the source AP and the target AP. Operation 640 corresponds to embodiments in which RSSI measurements are reported to the target AP after successful re-association via a dedicated action frame, rather than within the Reassociation Request frame 200. Because the action frame is transmitted only following a successful re-association, the measurements collected in this embodiment reflect only successful roaming events.

In operation 645, the target AP and the STA exchange a beacon report request and beacon report response. The target AP, after re-association completes, sends an IEEE 802.11k beacon report request to the STA specifying both the source AP and the target AP. Then, the STA responds with a beacon report that includes the RSSI at which the source AP was last heard and the RSSI at which the target AP was last observed (e.g., during the scan preceding roaming). Operation 645 corresponds to embodiments that leverage existing IEEE 802.11k mechanisms without requiring modification to standard frame formats. Because the beacon report response reflects the STA’s signal measurements at the time the request is issued (e.g., after re-association has completed) rather than at the precise moment the roaming decision was made, the resulting RSSI measurements may be somewhat less accurate than those reported in other embodiments (while being more accurate than AP RSSI measurements), particularly if the STA has moved between the roaming decision point and the time the beacon report is generated.

In operation 650, the target AP shares the collected STA RSSI measurements with the roaming application 130. The roaming application 130 uses the received measurements to update and refine the midpoint RSSI values for the AP pair, for example by computing or updating a mean or otherwise representative RSSI value across accumulated roaming events. In some embodiments, the target AP may instead share the measurements directly with the source AP, which accumulates the measurements over time and computes representative midpoint RSSI values for the AP pair. In all cases, the updated midpoint RSSI values are made available for inclusion in the neighbor AP information provided to subsequent STAs in operation 620, thereby improving roaming accuracy as additional roaming events are collected for each AP pair.

In operation 655, the STA sends a disassociation or deauthentication frame 500 to the source AP. In a third embodiment, the frame body 505 of the disassociation or deauthentication frame 500 includes a STA RSSI Measurements field 510 carrying the RSSI of the last packet received from the source AP and the RSSI of the first packet received from the target AP at the time the roaming decision was made. Transmitting the RSSI measurements to the source AP in the disassociation or deauthentication frame makes the data immediately available at the source AP without requiring communication between the target AP and the source AP.

In operation 660, the source AP shares the collected STA RSSI measurements with the roaming application 130 for determining or updating midpoint RSSI values. In operation 665, the roaming application 130 returns midpoint RSSI values to the source AP. Operations 640, 650, and 655 represent alternative reporting embodiments and are not mutually exclusive. A given network deployment may support one or more of these embodiments depending on the capabilities of the STA and the network infrastructure.

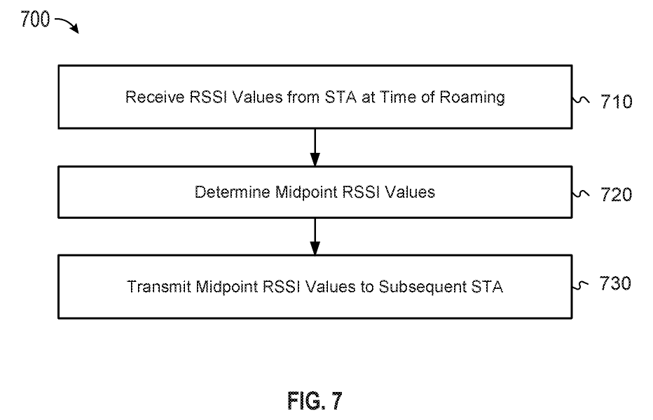

FIG. 7 is a flowchart illustrating a method 700 for roaming using STA RSSI feedback. The method 700 may be performed by a wireless network infrastructure, such as the first AP 102, the second AP 104, the third AP 106, the fourth AP 108, the controller 120, the roaming application 130, and/or a combination thereof, in the operating environment 100 of FIG. 1.

In stage 710, the network infrastructure receives, from a STA performing a roaming event from a source AP to a target AP, a report comprising one or more RSSI values measured at the STA at the time of the roaming event. The one or more RSSI values reflect the signal conditions as received and measured at the STA at or near the point at which the STA made the decision to roam. In one embodiment, the one or more RSSI values comprise a first RSSI value of the last packet received by the STA from the source AP at the time of the roaming event and a second RSSI value of the first packet received by the STA from the target AP at the time of the roaming event, capturing the STA’s view of both APs at the roaming location.

The report may be received in a number of ways depending on the embodiment. In one embodiment, the report is a Reassociation Request frame 200 sent by the STA to the target AP, or an action frame sent by the STA to the target AP after successful re-association with the target AP. In another embodiment, the report is a deauthentication frame or disassociation frame 500 sent by the STA to the source AP at the time of departure from the source AP. In some embodiments, stage 710 comprises the target AP transmitting, to the STA after re-association completes, a beacon report request specifying the source AP and the target AP, and receiving from the STA a beacon report response comprising the one or more RSSI values measured at the STA. In another embodiment, stage 710 comprises the target AP transmitting, to the STA after re-association completes, a table report request specifying the source AP and the target AP, and receiving from the STA a table report response comprising the one or more RSSI values measured at the STA.

In some embodiments, prior to stage 710, the source AP transmits to the STA a management frame (e.g., including one or more Neighbor Report elements 300, a BTM Request frame 400) comprising an RSSI Report Flag set to request that the STA report RSSI values measured at the STA at the time of the roaming event. The RSSI Report Flag further signals to the STA that the RSSI reporting mechanism is supported by the network infrastructure. The RSSI Report Flag may specify a reporting trigger. Foror example, the reporting trigger is a first trigger requesting the STA to report when the target AP is first detected, a second trigger requesting the STA to report upon completion of roaming to the target AP, or both. The STA reports both the RSSI at which it heard the target AP and the RSSI at which it heard the source AP at that same point in time and space.

In stage 720, the network infrastructure determines, based at least on the one or more RSSI values measured at the STA received in stage 710, a midpoint RSSI value for a roaming transition between the source AP and the target AP. The midpoint RSSI value represents the signal condition, as measured at a STA, at which roaming between the source AP and the target AP is to be performed. In one embodiment, determining the midpoint RSSI value comprises applying one or more ML or AI models to a plurality of RSSI values measured at a plurality of STAs during respective roaming events between the source AP and the target AP. The ML or AI models may be applied by the roaming application 130 and may be refined over time as additional roaming events are collected for the AP pair. In a non-ML embodiment, the target AP shares the received RSSI values with the source AP, which accumulates measurements over time and computes a mean or otherwise representative midpoint RSSI value for the AP pair.

In some embodiments, determining the midpoint RSSI value in stage 720 is performed on a per-device-class basis, using at least one of device model information or device brand information associated with reporting STAs such that the midpoint RSSI value is determined based on RSSI values measured at STAs of the same device class. Because STAs of the same device type or brand tend to exhibit similar received signal strength measurements at the same physical location, per-device-class midpoint RSSI values provide more accurate roaming guidance tailored to the RF characteristics of specific STA types. In some embodiments, stage 720 further comprises determining the midpoint RSSI value independently for each direction of an AP pair.

In stage 730, the network infrastructure transmits, to a subsequent STA associated with the source AP, a frame comprising the midpoint RSSI value to enable the subsequent STA to determine when to initiate roaming toward the target AP. In one embodiment, the frame is a Neighbor Report element 300 included in a management frame, wherein the optional subelements 305 include the midpoint RSSI value field 310 carrying the midpoint RSSI value. In another embodiment, the frame is a BTM Request frame 400. The subsequent STA uses the midpoint RSSI value to monitor its own received signal strength from the source AP and initiate roaming when the observed RSSI approaches the midpoint RSSI value, without requiring a full channel scan.

FIG. 8 is a block diagram of a computing device 800. As shown in FIG. 8, computing device 800 may include a processing unit 810 and a memory unit 815. Memory unit 815 may include a software module 820 and a database 825. While executing on processing unit 810, software module 820 may perform, for example, processes for providing zero-scan roaming with STA RSSI feedback. Computing device 800, for example, may provide an operating environment for the first AP 102, the second AP 104, the third AP 106, the fourth AP 108, the STA 110, the controller 120, the roaming application 130, and the like. The first AP 102, the second AP 104, the third AP 106, the fourth AP 108, the STA 110, the controller 120, the roaming application 130, and the like may operate in other environments and are not limited to computing device 800.

Computing device 800 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 800 may comprise any computer operating environment, such as hand-held devices, multiprocessor systems, microprocessor-based or programmable sender electronic devices, minicomputers, mainframe computers, and the like. Computing device 800 may also be practiced in distributed computing environments where tasks are performed by remote processing devices. The aforementioned systems and devices are examples, and computing device 800 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device. In one example, there is provided a computer readable medium carrying instructions which, when executed by one or more processors, cause any of the methods described herein to be carried out.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 800 on the single integrated circuit (chip).

FIG. 9 illustrates an implementation of a communications device 900 that may implement one or more of the first AP 102, the second AP 104, the third AP 106, the fourth AP 108, the STA 110, the controller 120, the roaming application 130, etc. In various implementations, the communications device 900 may comprise a logic circuit. The logic circuit may include physical circuits to perform operations described for one or more of the first AP 102, the second AP 104, the third AP 106, the fourth AP 108, the STA 110, the controller 120, the roaming application 130, the controller 120, etc., for example. As shown in FIG. 9, the communications device 900 may include one or more of, but is not limited to, a radio interface 910, baseband circuitry 930, and/or the computing device 800.

The communications device 900 may implement some or all of the structures and/or operations for the first AP 102, the second AP 104, the third AP 106, the fourth AP 108, the STA 110, the controller 120, the roaming application 130, etc., storage medium, and logic circuit in a single computing entity, such as entirely within a single device. Alternatively, the communications device 900 may distribute portions of the structure and/or operations using a distributed system architecture, such as a client station server architecture, a peer-to-peer architecture, a master-slave architecture, etc.

A radio interface 910, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 910 may include, for example, a receiver 915 and/or a transmitter 920. The radio interface 910 may include bias controls, a crystal oscillator, and/or one or more antennas 925. In additional or alternative configurations, the radio interface 910 may use oscillators and/or one or more filters, as desired.

The baseband circuitry 930 may communicate with the radio interface 910 to process, receive, and/or transmit signals and may include, for example, an Analog-To-Digital Converter (ADC) for down converting received signals with a Digital-To-Analog Converter (DAC) 935 for up converting signals for transmission. Further, the baseband circuitry 930 may include a baseband or PHY layer processing circuit for the PHY link layer processing of respective receive/transmit signals. Baseband circuitry 930 may include, for example, a MAC processing circuit 940 for MAC/data link layer processing. Baseband circuitry 930 may include a memory controller for communicating with MAC processing circuit 940 and/or a computing device 800, for example, via one or more interfaces 945.

In some configurations, PHY processing circuit may include a frame construction and/or detection module, in combination with additional circuitry such as a buffer memory, to construct and/or deconstruct communication frames. Alternatively or in addition, MAC processing circuit 940 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
receiving, from a station (STA) performing a roaming event from a source access point (AP) to a target AP, a report comprising one or more received signal strength indicator (RSSI) values measured at the STA at a time of the roaming event;
determining, based at least on the one or more RSSI values measured at the STA, a midpoint RSSI value for a roaming transition between the source AP and the target AP, the midpoint RSSI value representing a signal condition at which roaming between the source AP and the target AP is to be performed; and
transmitting, to a subsequent STA associated with the source AP, a frame comprising the midpoint RSSI value to enable the subsequent STA to determine when to initiate roaming toward the target AP.

2. The method of claim 1, wherein the one or more RSSI values measured at the STA comprise a first RSSI value of a last packet received by the STA from the source AP at the time of the roaming event and a second RSSI value of a first packet received by the STA from the target AP at the time of the roaming event.

3. The method of claim 1, wherein the report is a reassociation request frame sent to the target AP or an action frame sent to the target AP after successful re-association of the STA with the target AP.

4. The method of claim 1, wherein the report is a deauthentication frame or a disassociation frame sent to the source AP.

5. The method of claim 1, further comprising:
prior to receiving the report, transmitting, by the source AP to the STA, a management frame comprising an RSSI report flag set to request that the STA report the RSSI values measured at the STA at the time of the roaming event.

6. The method of claim 5, wherein the RSSI report flag specifies a reporting trigger, wherein the reporting trigger is a first trigger requesting the STA to report the RSSI values when the target AP is first detected by the STA or a second trigger requesting the STA to report the RSSI values upon completion of roaming to the target AP.

7. The method of claim 1, wherein receiving the report comprises:
transmitting, by the target AP to the STA after re-association of the STA with the target AP completes, a beacon report request specifying the source AP and the target AP; and
receiving, at the target AP from the STA, a beacon report response comprising the one or more RSSI values measured at the STA at the time of the roaming event.

8. The method of claim 1, wherein determining the midpoint RSSI value comprises applying one or more machine learning or artificial intelligence models to a plurality of RSSI values measured at a plurality of STAs during respective roaming events between the source AP and the target AP.

9. The method of claim 1, wherein receiving the report comprises:
transmitting, by the target AP to the STA after re-association of the STA with the target AP completes, a table report request specifying the source AP and the target AP; and
receiving, at the target AP from the STA, a table report response comprising the one or more RSSI values measured at the STA at the time of the roaming event.

10. A system comprising:
a memory storage; and
a processing unit coupled to the memory storage, wherein the processing unit is operative to:
receive, from a station (STA) performing a roaming event from a source access point (AP) to a target AP, a report comprising one or more received signal strength indicator (RSSI) values measured at the STA at a time of the roaming event;
determine, based at least on the one or more RSSI values measured at the STA, a midpoint RSSI value for a roaming transition between the source AP and the target AP, the midpoint RSSI value representing a signal condition at which roaming between the source AP and the target AP is to be performed; and
transmit, to a subsequent STA associated with the source AP, a frame comprising the midpoint RSSI value to enable the subsequent STA to determine when to initiate roaming toward the target AP.

11. The system of claim 10, wherein the one or more RSSI values measured at the STA comprise a first RSSI value of a last packet received by the STA from the source AP at the time of the roaming event and a second RSSI value of a first packet received by the STA from the target AP at the time of the roaming event.

12. The system of claim 10, wherein the report is a reassociation request frame sent to the target AP, an action frame sent to the target AP after successful re-association of the STA with the target AP, or a deauthentication frame or a disassociation frame sent to the source AP.

13. The system of claim 10, wherein the processing unit is further operative to:
prior to receiving the report, transmit the STA a management frame comprising an RSSI report flag set to request that the STA report the RSSI values measured at the STA at the time of the roaming event.

14. The system of claim 10, wherein to receive the report comprises to:
transmit, to the STA after re-association of the STA with the target AP completes, a beacon report request specifying the source AP and the target AP; and
receive a beacon report response comprising the one or more RSSI values measured at the STA at the time of the roaming event.

15. A non-transitory computer-readable medium that stores a set of instructions which when executed by a processing unit, cause the processing unit to perform a method comprising:
receiving, from a station (STA) performing a roaming event from a source access point (AP) to a target AP, a report comprising one or more received signal strength indicator (RSSI) values measured at the STA at a time of the roaming event;
determining, based at least on the one or more RSSI values measured at the STA, a midpoint RSSI value for a roaming transition between the source AP and the target AP, the midpoint RSSI value representing a signal condition at which roaming between the source AP and the target AP is to be performed; and
transmitting, to a subsequent STA associated with the source AP, a frame comprising the midpoint RSSI value to enable the subsequent STA to determine when to initiate roaming toward the target AP.

16. The non-transitory computer-readable medium of claim 15, wherein the one or more RSSI values measured at the STA comprise a first RSSI value of a last packet received by the STA from the source AP at the time of the roaming event and a second RSSI value of a first packet received by the STA from the target AP at the time of the roaming event.

17. The non-transitory computer-readable medium of claim 15, wherein the report is a reassociation request frame sent to the target AP, an action frame sent to the target AP after successful re-association of the STA with the target AP, or a deauthentication frame or a disassociation frame sent to the source AP.

18. The non-transitory computer-readable medium of claim 15, the method executed by the set of instructions further comprising:
prior to receiving the report, transmitting to the STA a management frame comprising an RSSI report flag set to request that the STA report the RSSI values measured at the STA at the time of the roaming event.

19. The non-transitory computer-readable medium of claim 15, wherein receiving the report comprises:
transmitting, to the STA after re-association of the STA with the target AP completes, a beacon report request specifying the source AP and the target AP; and
receiving, at the target AP from the STA, a beacon report response comprising the one or more RSSI values measured at the STA at the time of the roaming event.

20. The non-transitory computer-readable medium of claim 15, wherein determining the midpoint RSSI value comprises applying one or more machine learning or artificial intelligence models to a plurality of RSSI values measured at a plurality of STAs during respective roaming events between the source AP and the target AP.
